(19) United States
(12) Patent Application Publication
(10) Pub. No.: US 2013/0140748 A1
(43) Pub. Date: Jun. 6, 2013

(54) SYSTEM AND METHOD FOR DEGASSING MOLTEN METAL

(71) Applicant: Paul V. Cooper, Chesterland, OH (US)

(72) Inventor: Paul V. Cooper, Chesterland, OH (US)

(21) Appl. No.: 13/756,468

(22) Filed: Jan. 31, 2013

Related U.S. Application Data
(63) Continuation of application No. 12/853,253, filed on Aug. 9, 2010, now Pat. No. 8,366,993.
Application No. 12/853,253 is a continuation-in-part of application No. 11/766,617, filed on Jun. 21, 2007, now Pat. No. 8,337,746.
(60) Provisional application No. 61/232,386, filed on Aug. 7, 2009.

(51) Int. Cl. F27D 99/00

(52) U.S. Cl. CPC F27D 99/00
USPC 266/217

(57) ABSTRACT

A system for adding gas to and transferring molten metal from a vessel and into one or more of a ladle, ingot mold, launder, feed die cast machine or other structure is disclosed. The system includes at least a vessel for containing molten metal, an overflow (or dividing) wall, a device or structure, such as a molten metal pump, for generating a stream of molten metal, and one or more gas-release devices.

### CROSS REFERENCE TO RELATED APPLICATIONS

This application is a continuation of and claims priority to U.S. patent application Ser. No. 12/853,253 filed Aug. 9, 2010, which is a continuation-in-part of and claims priority to U.S. patent application Ser. No. 11/766,617, filed Jun. 21, 2007, now U.S. Pat. No. 8,337,746 issued Dec. 25, 2012, the disclosures of which are incorporated herein by reference in their entirety for all purposes. This application also claims priority to U.S. Provisional Patent Application No. 61/232,386, filed on Aug. 7, 2009, the disclosure of which is incorporated herein by reference in its entirety for all purposes.

### FIELD OF THE INVENTION

The invention comprises a system and method for adding gas to and moving molten metal out of a vessel, such as a reverbatory furnace.

### BACKGROUND OF THE INVENTION

As used herein, the term “molten metal” means any metal or combination of metals in liquid form, such as aluminum, copper, iron, zinc, and alloys thereof. The term “gas” means any gas or combination of gases, including argon, nitrogen, chlorine, fluorine, Freon, and helium, which may be released into molten metal.

A reverbatory furnace is used to melt metal and retain the molten metal while the metal is in a molten state. The molten metal in the furnace is sometimes called the molten metal bath. Reverbatory furnaces usually include a chamber for retaining a molten metal pump and that chamber is sometimes referred to as the pump well.

Known pumps for pumping molten metal (also called “molten-metal pumps”) include a pump base (also called a “base”, “housing” or “casing”) and a pump chamber (or “chamber” or “molten metal pump chamber”), which is an open area formed within the pump base. Such pumps also include one or more inlets in the pump base, an inlet being an opening to allow molten metal to enter the pump chamber.

A discharge is formed in the pump base and is a channel or conduit that communicates with the molten metal pump chamber, and leads from the pump chamber to the molten metal bath. A tangential discharge is a discharge formed at a tangent to the pump chamber. The discharge may also be axial, in which case the pump is called an axial pump. In an axial pump the pump chamber and discharge may be the essentially the same structure (or different areas of the same structure) since the molten metal entering the chamber is expelled directly through (usually directly above or below) the chamber.

A rotor, also called an impeller, is mounted in the pump chamber and is connected to a drive shaft. The drive shaft is typically a motor shaft coupled to a rotor shaft, wherein the motor shaft has two ends, one end being connected to a motor and the other end being coupled to the rotor shaft. The rotor shaft also has two ends, wherein one end is coupled to the motor shaft and the other end is connected to the rotor. Often, the rotor shaft is comprised of graphite, the motor shaft is comprised of steel, and the two are coupled by a coupling, which is usually comprised of steel.

As the motor turns the drive shaft, the drive shaft turns the rotor and the rotor pushes molten metal out of the pump chamber, through the discharge, which may be an axial or tangential discharge, and into the molten metal bath. Most molten metal pumps are gravity fed, wherein gravity forces molten metal through the inlet and into the pump chamber as the rotor pushes molten metal out of the pump chamber.

Molten metal pump casings and rotors usually, but not necessarily, employ a bearing system comprising ceramic rings wherein there are one or more rings on the rotor that align with rings in the pump chamber such as rings at the inlet (which is usually the opening in the housing at the top of the pump chamber and/or bottom of the pump chamber) when the rotor is placed in the pump chamber. The purpose of the bearing system is to reduce damage to the soft, graphite components, particularly the rotor and pump chamber wall, during pump operation. A known bearing system is described in U.S. Pat. No. 5,203,681 to Cooper, the disclosure of which is incorporated herein by reference. U.S. Pat. Nos. 5,951,243 and 6,093,000, each to Cooper, the disclosures of which are incorporated herein by reference, disclose, respectively, bearings that may be used with molten metal pumps and rigid coupling designs and a monolithic rotor. U.S. Pat. No. 2,948,524 to Sweeney et al., U.S. Pat. No. 4,169,584 to Mangalick, and U.S. Pat. No. 6,123,523 to Cooper (the disclosure of the afore-mentioned patent to Cooper is incorporated herein by reference) also disclose molten metal pump designs. U.S. Pat. No. 6,303,074 to Cooper, which is incorporated herein by reference, discloses a dual-flow rotor, wherein the rotor has at least one surface that pushes molten metal into the pump chamber.

The materials forming the molten metal pump components that contact the molten metal bath should remain relatively stable in the bath. Structural refractory materials, such as graphite or ceramics, that are resistant to disintegration by corrosive attack from the molten metal may be used. As used herein “ceramics” or “ceramic” refers to any oxidized metal (including silicon) or carbon-based material, excluding graphite, capable of being used in the environment of a molten metal bath. “Graphite” means any type of graphite, whether or not chemically treated. Graphite is particularly suitable for being formed into pump components because it is (a) soft and relatively easy to machine, (b) not as brittle as ceramics and less prone to breakage, and (c) less expensive than ceramics.

Three basic types of pumps for pumping molten metal, such as molten aluminum, are utilized: circulation pumps, transfer pumps and gas-release pumps. Circulation pumps are used to circulate the molten metal within a bath, thereby generally equalizing the temperature of the molten metal. Most often, circulation pumps are used in a reverbatory furnace having an external well. The well is usually an extension of a charging well where scrap metal is charged (i.e., added).

Transfer pumps are generally used to transfer molten metal from the external well of a reverbatory furnace to a different location such as a launder, ladle, or another furnace. Examples of transfer pumps are disclosed in U.S. Pat. No. 6,345,964 B1 to Cooper, the disclosure of which is incorporated herein by reference, and U.S. Pat. No. 5,203,681.

Gas-release pumps, such as gas-injection pumps, circulate molten metal while releasing a gas into the molten metal. In the purification of molten metals, particularly aluminum, it is frequently desired to remove dissolved gases such as hydrogen, or dissolved metals, such as magnesium, from the molten metal. As is known by those skilled in the art, the removing of dissolved gas is known as “degassing” while the removal of magnesium is known as “demagging.” Gas-release pumps may be used for either of these purposes or for any other application for which it is desirable to introduce gas into molten metal. Gas-release pumps generally include a gas-transfer conduit having a first end that is connected to a gas source and a second submerged in the molten metal bath. Gas is introduced into the first end of the gas-transfer conduit and is released from the second end into the molten metal. The gas may be released downstream of the pump chamber into either the pump discharge or a metal-transfer conduit extending from the discharge, or into a stream of molten metal exiting either the discharge or the metal-transfer conduit. Alternatively, gas may be released into the pump chamber or upstream of the pump chamber at a position where it enters the pump chamber. A system for releasing gas into a pump chamber is disclosed in U.S. Pat. No. 6,123,523 to Cooper. Furthermore, gas may be released into a stream of molten metal passing through a discharge or metal-transfer conduit wherein the position of a gas-release opening in the metal-transfer conduit enables pressure from the molten metal stream to assist in drawing gas into the molten metal stream. Such a structure and method is disclosed in U.S. application Ser. No. 10/773,101 entitled “System for Releasing Gas into Molten Metal”, invented by Paul V. Cooper, and filed on Feb. 4, 2004, the disclosure of which is incorporated herein by reference.

Furthermore, U.S. Pat. No. 7,402,276 to Cooper entitled “Pump With Rotating Inlet” (also incorporated by reference) discloses, among other things, a pump having an inlet and rotor structure (or other displacement structure) that rotate together as the pump operates in order to alleviate jamming.

Molten metal transfer pumps have been used, among other things, to transfer molten aluminum from a well to a ladle or launder, wherein the launder normally directs the molten aluminum into a ladle or into molds where it is cast into solid, usable pieces, such as ingots. The launder is essentially a trough, channel, or conduit outside of the reverbatory furnace. A ladle is a large vessel into which molten metal is poured from the furnace. After molten metal is placed into the ladle, the ladle is transported from the furnace area to another part of the facility where the molten metal inside the ladle is poured into molds. A ladle is typically filled in two ways. First, the ladle may be filled by utilizing a transfer pump positioned in the furnace to pump molten metal out of the furnace, over the furnace wall, and into the ladle. Second, the ladle may be filled by transferring molten metal from a hole (called a tap-out hole) located at or near the bottom of the furnace and into the ladle. The tap-out hole is typically a tapered hole or opening, usually about 1″-1½″ in diameter, that receives a tapered plug called a “tap-out plug.” The plug is removed from the tap-out hole to allow molten metal to drain from the furnace and inserted into the tap-out hole to stop the flow of molten metal out of the furnace.

There are problems with each of these known methods. Referring to filling a ladle utilizing a transfer pump, there is splashing (or turbulence) of the molten metal exiting the transfer pump and entering the ladle. This turbulence causes the molten metal to interact more with the air than would a smooth flow of molten metal pouring into the ladle. The interaction with the air leads to the formation of dross within the ladle and splashing also creates a safety hazard because persons working near the ladle could be hit with molten metal. Further, there are problems inherent with the use of most transfer pumps. For example, the transfer pump can develop a blockage in the riser, which is an extension of the pump discharge that extends out of the molten metal bath in order to pump molten metal from one structure into another. The blockage blocks the flow of molten metal through the pump and essentially causes a failure of the system. When such a blockage occurs the transfer pump must be removed from the furnace and the riser tube must be removed from the transfer pump and replaced. This causes hours of expensive downtime. A transfer pump also has associated piping attached to the riser to direct molten metal from the vessel containing the transfer pump into another vessel or structure. The piping is typically made of steel with an internal liner. The piping can be between 1 and 10 feet in length or even longer. The molten metal in the piping can also solidify causing failure of the system and downtime associated with replacing the piping.

If a tap-out hole is used to drain molten metal from a furnace a depression is formed in the floor or other surface on which the furnace rests so the ladle can preferably be positioned in the depression so it is lower than the tap-out hole, or the furnace may be elevated above the floor so the tap-out hole is above the ladle. Either method can be used to enable molten metal to flow from the tap-out hole into the ladle.

Use of a tap-out hole at the bottom of a furnace can lead to problems. First, when the tap-out plug is removed molten metal can splash or splatter causing a safety problem. This is particularly true if the level of molten metal in the furnace is relatively high which leads to a relatively high pressure pushing molten metal out of the tap-out hole. There is also a safety problem when the tap-out plug is reinserted into the tap-out hole because molten metal can splatter or splash onto personnel during this process. Further, after the tap-out hole is plugged, it can still leak. The leak may ultimately cause a fire, lead to physical harm of a person and/or the loss of a large amount of molten metal from the furnace that must then be cleaned up, or the leak and subsequent solidifying of the molten metal may lead to loss of the entire furnace.

Another problem with tap-out holes is that the molten metal at the bottom of the furnace can harden if not properly circulated thereby blocking the tap-out hole or the tap-out hole can be blocked by a piece of dross in the molten metal.

A launder may be used to pass molten metal from the furnace and into a ladle and/or into molds, such as molds for making ingots of cast aluminum. Several die cast machines, robots, and/or human workers may draw molten metal from the launder through openings (sometimes called plug taps). The launder may be of any dimension or shape. For example, it may be one to four feet in length, or as long as 100 feet in length. The launder is usually sloped gently, for example, it may be sloped downward or gently upward at a slope of approximately ⅛ inch per each ten feet in length, in order to use gravity to direct the flow of molten metal out of the launder, either towards or away from the furnace, to drain all or part of the molten metal from the launder once the pump supplying molten metal to the launder is shut off. In use, a typical launder includes molten aluminum at a depth of approximately 1-10.″

Whether feeding a ladle, launder or other structure or device utilizing a transfer pump, the pump is turned off and on according to when more molten metal is needed. This can be done manually or automatically. If done automatically, the pump may turn on when the molten metal in the ladle or launder is below a certain amount, which can be measured in any manner, such as by the level of molten metal in the launder or level or weight of molten metal in a ladle. A switch activates the transfer pump, which then pumps molten metal from the pump well, up through the transfer pump riser, and into the ladle or launder. The pump is turned off when the molten metal reaches a given amount in a given structure, such as a ladle or launder. This system suffers from the problems previously described when using transfer pumps. Further, when a transfer pump is utilized it must operate at essentially full speed in order to generate enough pressure to push molten metal upward through the riser and into the ladle or launder. Therefore, there can be lags wherein there is no or too little molten metal exiting the transfer pump riser and/or the ladle or launder could be over filled because of a lag between detection of the desired amount having been reached, the transfer pump being shut off, and the cessation of molten metal exiting the transfer pump.

Conventional systems also require a circulation pump in addition to a transfer pump to keep the molten metal in the well at a constant temperature, as well as a transfer pump to transfer molten metal into a ladle, launder and/or other structure. Further, it would be beneficial to remove unwanted gasses just prior to molten metal entering a launder or ladle because it is less likely that there will be gas pockets in the igots.

### SUMMARY OF THE INVENTION

The present invention includes a system for adding gas to and transferring molten metal into another structure, such as a ladle or launder. A system according to an embodiment of the present invention comprises a vessel for containing molten metal and a raised chamber in fluid communication with the vessel. In this embodiment, the bottom interior surface of the raised chamber is positioned at least partially above the bottom interior surface of the vessel. The raised chamber includes a discharge for expelling molten metal, preferably into a launder, ladle or other vessel. One or more degassers are positioned in the raised chamber for releasing gas into the molten metal in the raised chamber. The vessel can be separated into two portions by a dividing wall (or overflow wall) within the vessel, the dividing wall having a height H1 and dividing the vessel into at least a first chamber and a second chamber, which is preferably the raised chamber.

The system may also include other devices and structures such as one or more of a ladle, an ingot mold, and/or launder positioned downstream of the raised chamber.

### BRIEF DESCRIPTION OF THE DRAWINGS

FIG. 1 is a partial, cross-sectional view of a system for adding gas to and pumping molten metal from, a vessel into another structure according to the invention.

FIG. 2A is a cross-sectional side view of the system in FIG. 1.

FIG. 2B is a cross-sectional side view depicting a sloped bottom surface of the second raised chamber according to an aspect of the present invention.

FIG. 3 is a partial, cross-sectional side view of an alternative embodiment of a system according to the invention.

FIG. 4 is a top prospective view of a system according to the invention that feeds two launders, each of which in turn fills a structure such as a ladle or ingot mold.

FIG. 5 is schematic representation of a system according to the invention illustrating how a laser could be used to detect the level of molten metal in a vessel.

FIG. 6 shows the system of FIG. 5 and represents different levels of molten metal in the vessel.

FIG. 7 shows the system of FIG. 5 in which the level of molten metal has decreased to a minimum level.

FIG. 8 shows a remote control panel that may be used to control a pump used in a system according to the invention.

FIG. 9 illustrates an exemplary dividing wall that may be used to partition two gas-release pumps according to various aspects of the present invention.

### DETAILED DESCRIPTION OF PREFERRED EMBODIMENTS

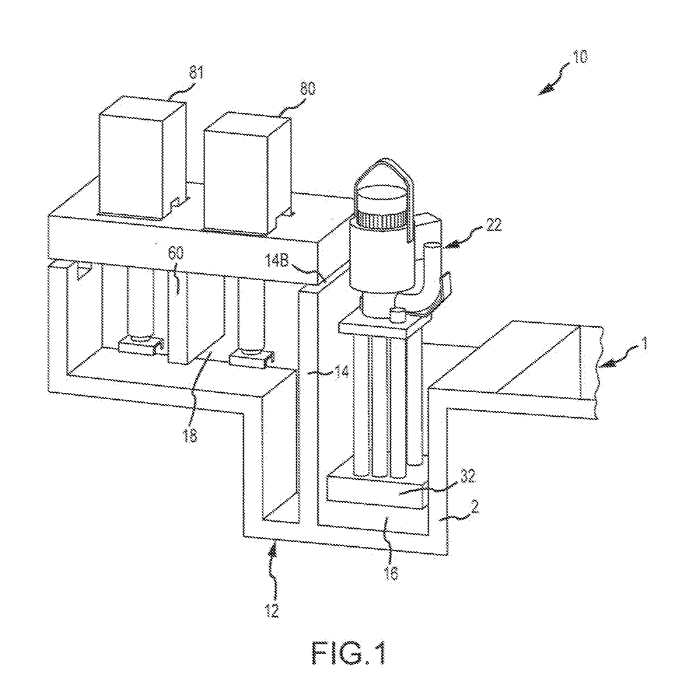

Turning now to the Figures, where the purpose is to describe preferred embodiments of the invention and not to limit same, FIGS. 1-4 show a system 10 for adding gas to molten metal M, and for transferring molten metal M into a structure (such as a ladle or a launder 20). System 10 includes a furnace 1 that can retain molten metal M, which includes a holding furnace 1A, a vessel 12, a launder 20, and a pump 22. System 10 further comprises a dividing wall 14 to separate vessel 12 into a first chamber 16 and a second raised chamber 18. A device or structure, such as pump 22, generates a stream of molten metal from the first chamber 16 into the second raised chamber 18. Degassers 80, 81 add gas to the molten metal M in the second raised chamber 18.

Using heating elements (not shown in the figures), furnace 1 is raised to a temperature sufficient to maintain the metal therein (usually aluminum or zinc) in a molten state. The level of molten metal M in holding furnace 1A and in at least part of vessel 12 changes as metal is added or removed to furnace 1A.

For explanation, although not important to the invention, furnace 1 includes a furnace wall 2 having an archway 3. Archway 3 allows molten metal M to flow into vessel 12 from holding furnace 1A. In this embodiment, furnace 1A and vessel 12 are in fluid communication, so when the level of molten metal in furnace 1A rises, the level also rises in at least part of vessel 12. The molten metal most preferably rises and falls in first chamber 16, described below, as the level of molten metal rises or falls in furnace 1A.

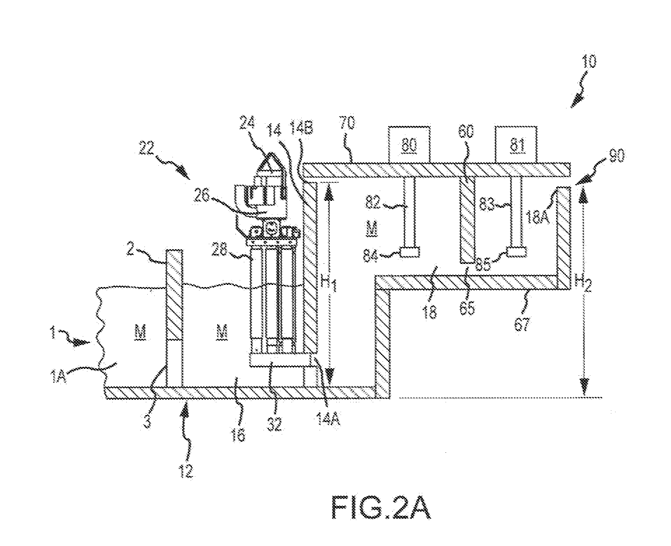

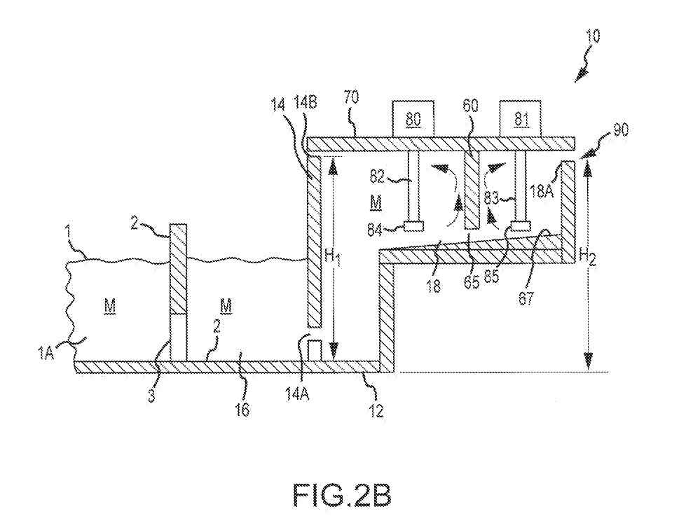

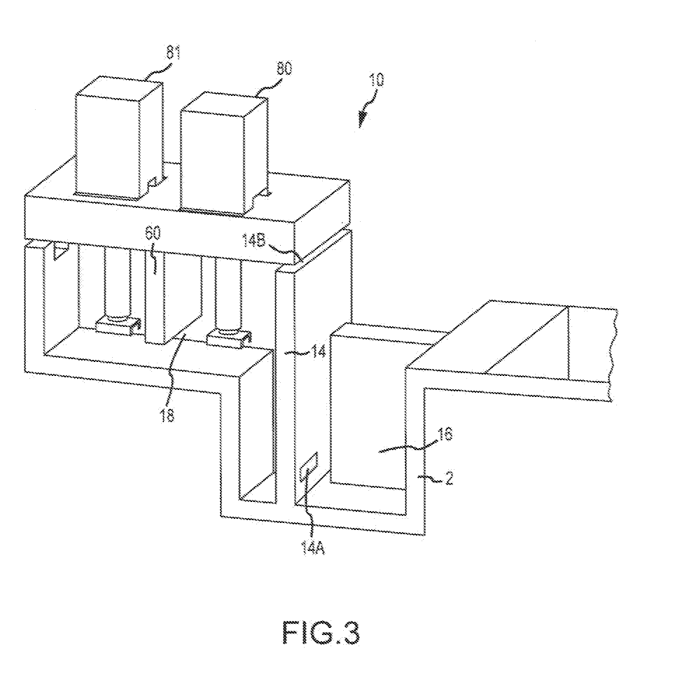

Dividing wall 14 separates vessel 12 into at least two chambers. In the exemplary embodiment depicted in FIGS. 1-4, the dividing wall 14 separates vessel into a pump well (also referred to herein as the “first chamber”) 16 and a raised skim well (also referred to herein as the “second raised chamber”) 18. The dividing wall 14 may be of any suitable size, shape, configuration, and composition for forming chambers in the vessel 12. As shown in this embodiment, dividing wall 14 has an opening 14A (best seen in FIGS. 2A, 2B, and 3) to allow molten metal M to flow from chamber 16 to raised chamber 18. The dividing wall 14 further comprises an overflow spillway 14B (best seen in FIG. 1 and FIG. 3). Overflow spillway 14B is any structure suitable to allow molten metal to flow from the second raised chamber 18, back into the first chamber 16. In the present exemplary embodiment, the overflow spillway 14B is a notch or cut out in the upper edge of dividing wall 14. The overflow spillway 14B may be positioned at any suitable location on wall 14. The purpose of optional overflow spillway 14B is to prevent molten metal from overflowing the second raised chamber 18, or a launder in communication with second raised chamber 18 (if a launder is used with the invention), by allowing molten metal in second raised chamber 18 to flow back into first chamber 16. Optional overflow spillway 14B is preferably not utilized during normal operation of system 10, but is to be used as a safeguard if the level of molten metal in second raised chamber 18 improperly rises to too high a level.

At least part of dividing wall 14 has a height H1 (best seen in FIGS. 2A and 2B), which is the height at which, if exceeded by molten metal in second raised chamber 18, molten metal flows past the portion of dividing wall 14 at height H1 and back into first chamber 16. In the embodiment shown in FIGS. 1-3, overflow spillway 14B has a height H1 and the rest of dividing wall 14 has a height greater than H1. Alternatively, dividing wall 14 may not have an overflow spillway, in which case all of dividing wall 14 could have a height H1, or dividing wall 14 may have an opening with a lower edge positioned at height H1, in which case molten metal could flow through the opening if the level of molten metal in second raised chamber 18 exceeded H1. H1 should exceed the highest level of molten metal in first chamber 16 during normal operation.

In one embodiment of the present invention, at least part of the interior bottom surface of second raised chamber 18 is positioned above the interior bottom surface of first raised chamber 16. The differential between the bottom surface of the second raised chamber 18 and the bottom surface of the first raised chamber 16 can be determined as needed to facilitate the flow and/or draining of molten metal between second raised chamber 18 and first chamber 16. The second raised chamber 18 has a portion 18A, which has a height H2, wherein H2 is less than H1 (as can be best seen in FIGS. 2A and 2B). During normal operation, molten metal pumped into the second raised chamber 18 flows past wall 18A and out of second raised chamber 18 through discharge 90, rather than flowing back over dividing wall 14 and into first chamber 16. At least a portion of the discharge 90 has height H2. In the present exemplary embodiment, the entire lower edge of the discharge 90 is at height H2 to allow molten metal to flow out from the raised chamber 18.

The second raised chamber 18 includes at least one (preferably two or more) degassers (80, 81) that are coupled to the second raised chamber 18 for releasing gas into the molten metal M. The present invention may operate in conjunction with any type of degasser. In the present exemplary embodiment, the degassers 80, 81 are rotary degassers, such as of the type described in U.S. Pat. No. 5,678,807 to Cooper, the disclosure of which is incorporated by reference herein in its entirety. The rotary degassers 80, 81 are coupled to the top surface 70 of the raised chamber 18. Each rotary degasser includes a shaft 82, 83 that extends into the raised chamber 18, and an impeller block 84, 85 coupled to the respective shafts. The rotary degassers 80, 81 maybe positioned in any suitable manner. In the present embodiment, for example, the bottom surfaces of the impeller blocks 84, 85 are substantially parallel to each other, and each block extends below the bottom surface of the dividing wall 60. The second raised chamber 18 may also include one or more gas release and/or circulation pumps.

As shown in FIGS. 2A and 2B, the second raised chamber 18 may include a dividing wall 60 to, among other things, divert the flow of molten metal and/or gas within the second raised chamber 18. The dividing wall 60 can be made out of any suitable material, such as the material that forms the second raised chamber 18. In the exemplary embodiment depicted in FIGS. 1-3 and 9, the dividing wall 60 creates a partial partition between degassers 80, 81. In this embodiment, the dividing wall 60 extends between the front and back surfaces of the second raised chamber 18, and downward from the interior of the top surface 70 of the second raised chamber 18. The dividing wall 60 aids the degassers 80, 81 in releasing gas into the molten metal in the second raised chamber 18. The dividing wall 60 also aids in reducing dross or impurities that collect on the surface of the molten metal from flowing from second raised chamber 18.

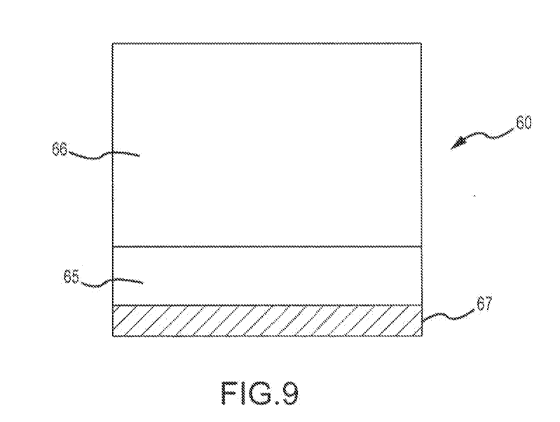

The dividing wall 60 allows molten metal to flow within the raised chamber 18. The dividing wall 60 may be of any size, shape, and configuration in order to allow molten metal to flow through the raised chamber 18 and out through the discharge 90. In the present exemplary embodiment, an opening 65 between the dividing wall 60 and bottom surface 67 of the second chamber 18 allows molten metal to flow through the raised chamber 18. The opening 65 between the dividing wall 60 and the raised chamber 18 may be any size, shape, configuration, and location. As shown in FIG. 9, for example, the opening 65 in the present exemplary embodiment is substantially rectangular. Alternately, the dividing wall and interior of the second chamber 18 may form an opening that is rounded, or that has any other suitable shape. In alternate embodiments, the dividing wall 60 may include one or more openings (having any suitable size, shape, configuration, and location) to allow molten metal to flow through the second chamber 18. Such openings may be in addition to any openings or gaps between the dividing wall and the interior surface of the second chamber 18.

The second raised chamber 18 includes a top surface 70 above the overflow spillway 14B to which the pumps 80, 81 are mounted. In one embodiment of the present invention, the top surface 70 is removable to allow access to the interior of the raised chamber 18 to, for example, facilitate the removal of dross and unwanted materials, and to allow cleaning the interior surface of the raised chamber 18. Similarly, any other surface or portion of the system 10 may be removably attached to the system 10 to aid in access, cleaning, or repair of the system 10.

The second raised chamber 18 may be any size, shape, and configuration. In one exemplary embodiment of the present invention, as seen in FIG. 2B, the interior bottom surface of second raised chamber 18 is sloped towards dividing wall 14. This assists in draining molten metal from the second raised chamber 18. Similarly, the bottom surface of the raised chamber 18 can be concave or convex to help drain molten metal from the raised chamber 18.

In another embodiment of the present invention, the raised chamber 18 can be configured to receive a flow of molten metal from any known system for transferring molten metal. In this embodiment, molten metal may be provided through the opening 14A from a launder, vessel, and/or pump discharge.

The opening 14A is located at a depth such that opening 14A is submerged within the molten metal during normal usage, and opening 14A is preferably near or at the bottom of dividing wall 14. Opening 14A preferably has an area of between 6 in.² and 24 in.², but could be any suitable size. Further, dividing wall 14 need not have an opening if a transfer pump were used to transfer molten metal from first chamber 16, over the top of wall 14, and into second raised chamber 18 as described below.

Dividing wall 14 may also include more than one opening between first chamber 16 and second raised chamber 18 and opening 14A (or the more than one opening) could be positioned at any suitable location(s) in dividing wall 14 and be of any size(s) or shape(s) to enable molten metal to pass from first chamber 16 into second raised chamber 18.

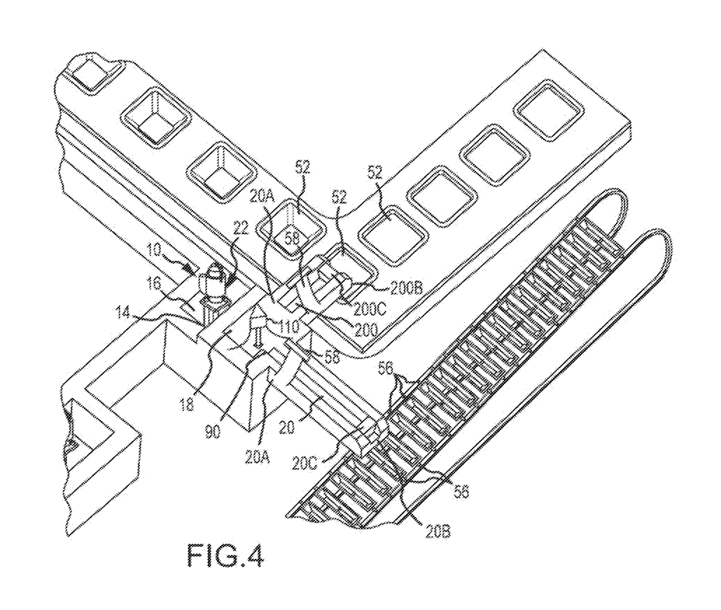

As shown in FIG. 4, the discharge 90 of the raised chamber 18 can be coupled to a launder 20. The launder 20 (or any launder according to the invention) is any structure or device for transferring molten metal from vessel 12 to one or more structures, such as one or more ladles, molds (such as ingot molds) or other structures in which the molten metal is ultimately cast into a usable form, such as an ingot. Launder 20 may be either an open or enclosed channel, trough or conduit and may be of any suitable dimension or length, such as one to four feet long or as much as 100 feet long or longer. Launder 20 may be completely horizontal or may slope gently upward or downward. Launder 20 may have one or more taps (not shown), i.e., small openings stopped by removable plugs. Each tap, when unstopped, allows molten metal to flow through the tap into a ladle, ingot mold, or other structure. Launder 20 may additionally or alternatively be serviced by robots or cast machines capable of removing molten metal M from launder 20.

Launder 20 has a first end 20A coupled to the discharge 90 of the second raised chamber 18, and a second end 20B that is opposite first end 20A. An optional stop may be included in a launder according to the invention. The stop, if used, is preferably coupled to the second end 20B. Such an arrangement is shown in FIG. 4 with respect to launder 20 and stop 20C, as well as with launder 200 and stop 200C. With regard to stop 200C, it can be opened to allow molten metal to flow past end 200B, or closed to prevent molten metal from flowing past end 200B. Stop 200C (or any stop according to the invention) preferably has a height H3 greater than height H1 so that if launder 20 becomes too filled with molten metal, the molten metal would spill back over dividing wall 14A (over spillway 14B, if used) rather than overflow launder 200. Stop 20C is structured and functions in the same manner as stop 200C.

Molten metal pump 22 may be any device or structure capable of pumping or otherwise conveying molten metal. Pump 22 is preferably a circulation pump (most preferred) or gas-release pump that generates a flow of molten metal from first chamber 16 to second raised chamber 18 through opening 14A. Pump 22 generally includes a motor 24 surrounded by a cooling shroud 26, a superstructure 28, support posts 30 and a base 32. Some pumps that may be used with the invention are shown in U.S. Pat. Nos. 5,203,681, 6,123,523 and 6,354,964 to Cooper, and pending U.S. application Ser. No. 12/120,190 to Cooper. Molten metal pump 22 can be a constant speed pump, but is most preferably a variable speed pump. Its speed can be varied depending on the amount of molten metal in a structure such as a ladle or launder, as discussed below.

As pump 22 pumps molten metal from first chamber 16 into second raised chamber 18, the level of molten metal in chamber 18 rises. When a pump with a discharge (such as circulation pump or gas-release pump) is submerged in the molten metal bath of first chamber 16, there is essentially no turbulence or splashing. This reduces the formation of dross and reduces safety hazards. Further, the afore-mentioned problems with transfer pumps are eliminated. The flow of molten metal is smooth and generally at a slower flow rate than molten metal flowing through a metal transfer pump or associated piping, or than molten metal exiting a tap-out hole.

When the level of molten metal M in second raised chamber 18 exceeds H2, the molten metal moves out of second raised chamber 18 through discharge 90 and into one or more other structures, such as one or more ladles, one or more launders and/or one or more ingot molds.

FIG. 4 shows an alternate system 10’ that is in all respects the same as system 10 except that it includes a single rotary degasser 110 in second raised chamber 18, and feeds either of the two launders shown, i.e., launder 20 and launder 200 (both previously described), or feeds both launders simultaneously. If only one launder is fed, a dam will typically be positioned to block flow into the other launder. Launder 20 feeds ladles 52, which are shown as being positioned on or formed as part of a continuous belt. Launder 200 feeds ingot molds 56, which are shown as being positioned on or formed as part of a continuous belt. However, launder 20 and launder 200 could feed molten metal, respectively, to any structure or structures.

A system according to the invention could also include one or more pumps in addition to pump 22, in which case the additional pump(s) may circulate molten metal within first chamber 16 and/or second raised chamber 18, or from chamber 16 to chamber 18, and/or may release gas into the molten metal first in first chamber 16 or second raised chamber 18. For example, first chamber 16 could include pump 22 and a second pump, such as a circulation pump or gas-release pump, to circulate and/or release gas into molten metal M.

If pump 22 is a circulation pump or gas-release pump, it may be at least partially received in opening 14A in order to at least partially block opening 14A and maintain a relatively stable level of molten metal in second raised chamber 18 during normal operation, as well as to allow the level in second raised chamber 18 to rise independently of the level in first chamber 16. Utilizing this system, the movement of molten metal from the first chamber 16 to the second chamber 18, and from the second raised chamber 18 into the launder 20, does not involve raising molten metal above the surface of the molten metal M (e.g., through splashing or turbulence). As previously mentioned, this alleviates problems with blockage forming (because of the molten metal cooling and solidifying), and with turbulence and splashing, which can cause dross formation and safety problems. As shown, part of base 32 (preferably the discharge portion of the base) is received in opening 14A. Further, pump 22 may communicate with another structure, such as a metal-transfer conduit, that leads to and is received partially or fully in opening 14A. Although it is preferred that the pump base, or communicating structure such as a metal-transfer conduit, be received in opening 14A, all that is necessary for the invention to function is that the operation of the pump increases and maintains the level of molten metal in second raised chamber 18 so that the molten metal ultimately moves out of chamber 18 and into another structure. For example, the base of pump 22 may be positioned so that its discharge is not received in opening 14A, but is close enough to opening 14A that the operation of the pump raises the level of molten metal in second raised chamber 18 independent of the level in chamber 16 and causes molten metal to move out of second raised chamber 18 and into another structure. A sealant, such as cement (which is known to those skilled in the art), may be used to seal base 32 into opening 14A, although it is preferred that a sealant not be used.

A system according to the invention could also be operated with a transfer pump, although a pump with a submerged discharge, such as a circulation pump or gas-release pump, is preferred since either would be less likely to create turbulence and dross in second raised chamber 18, and neither raises the molten metal above the surface of the molten metal bath nor has the other drawbacks associated with transfer pumps that have previously been described. If a transfer pump were used to move molten metal from first chamber 16, over dividing wall 14, and into second raised chamber 18, there would be no need for opening 14A in dividing wall 14, although an opening could still be provided and used in conjunction with an additional circulation or gas-release pump. As previously described, regardless of what type of pump is used to move molten metal from first chamber 16 to second raised chamber 18, molten metal would ultimately move out of chamber 18 and into a structure, such as ladle 52 or launder 20, when the level of molten metal in second raised chamber 18 exceeds H2.

Pump 22 is preferably a variable speed pump and its speed is increased or decreased according to the amount of molten metal in a structure, such as second raised chamber 18, ladle 52 or launder 20 and/or 200. Similarly, degassers 80, 81 may be variable speed degassers, and their speeds can be varied based on the amount of molten metal in a structure in the same manner as pump 22. The pump 22 can operate at the same or different speeds as the degassers 80, and 81.

For example, if molten metal is being added to a ladle 52 (FIG. 5), the amount of molten metal in the ladle can be measured utilizing a float in the ladle, a scale that measures the combined weight of the ladle and the molten metal inside the ladle or a laser to measure the surface level of molten metal in a launder. When the amount of molten metal in the ladle is relatively low, pump 22 can be manually or automatically adjusted to operate at a relatively fast speed to raise the level of molten metal in second raised chamber 18 and cause molten metal to flow quickly out of second raised chamber 18 and ultimately into the structure (such as a ladle) to be filled. When the amount of molten metal in the structure (such as a ladle) reaches a certain amount, that is detected and pump 22 is automatically or manually slowed and eventually stopped to prevent overflow of the structure. Likewise, the speed of degassers 80 and 81 can be increased or decreased as the speed of pump 22 is increased or decreased.

Once pump 22 is turned off, the levels of molten metal level in second raised chamber 18 lowers, filling first chamber 16. This level reduction can be used to clear second raised chamber 18 of molten metal, reducing cleaning time between multiple molten metal transfers through the system. As discussed previously, the raised chamber 18 may include a slope on its interior bottom surface (or other advantageous shape) to help molten metal flow back into the first chamber 16 when the pump is turned off. Alternatively, the speed of pump 22 could be reduced to a relatively low speed to keep the level of molten metal in second raised chamber 18 relatively constant but not exceed height H2. To fill another ladle, pump 22 is simply turned on again and operated as described above. In this manner ladles, or other structures, can be filled efficiently with less turbulence, less potential for dross formation and lags wherein there is too little molten metal in the system, and fewer or none of the other problems associated with known systems that utilize a transfer pump or pipe.

Another advantage of a system according to the invention is that a single pump could simultaneously feed molten metal to multiple (i.e., a plurality) of structures, or alternatively be configured to feed one of a plurality of structures depending upon the placement of one or more dams to block the flow of molten metal into one or more structures. For example, system 10 or any system described herein could fill multiple ladles, launders, and/or ingot molds, or a dam(s) could be positioned so that system 10 fills just one or less than all of these structures. The system shown in FIG. 4 includes a single pump 22 that causes molten metal to move from first chamber 16 into second raised chamber 18, where it finally passes out of second raised chamber 18 and into either one of two launders 20 and 200 if a dam is used, or into both launders simultaneously, or into a single launder that splits into multiple branches. As shown, one launder 20 fills ladles 52, while there is a dam blocking the flow of molten metal into launder 200, which would be used to fill ingot molds 56. Alternatively, a launder could be used to fill a feed die cast machine or any other structure.

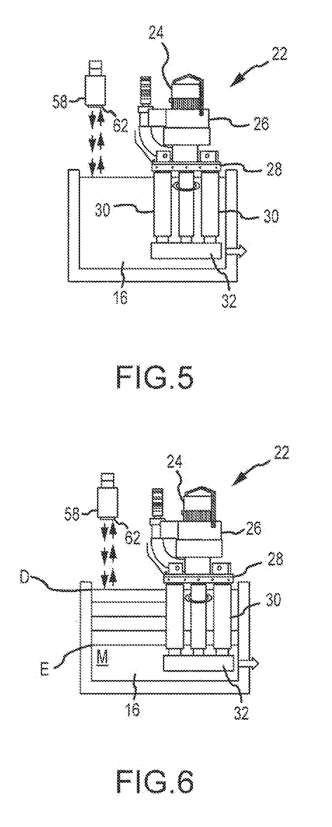

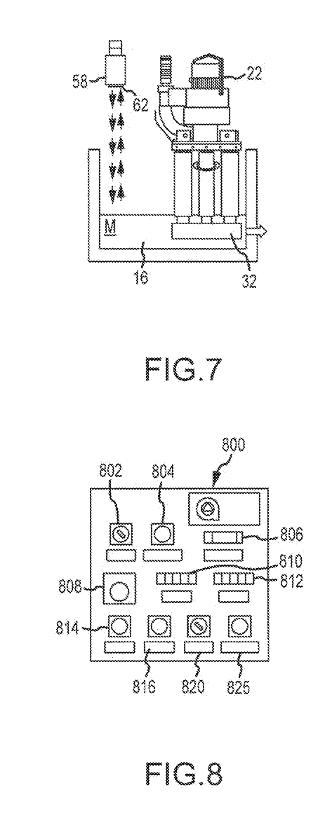

FIGS. 5-8 show an alternative system 100 in accordance with the invention, which is in all aspects the same as system 10 except that system 100 includes a control system (not shown) and device 58 to detect the amount of molten metal M within a structure such as a ladle or launder, each of which could function with any system according to the invention. The control system may or may not be used with a system according to the invention and can vary the speed of, and/or turn off and on, molten metal pump 22 and/or degassers 80, 81 in accordance with a parameter of molten metal M within a structure (such a structure could be a ladle, launder, first chamber 16 or second raised chamber 18). For example, if the parameter were the amount of molten metal in a ladle, when the amount of molten metal M within the ladle is low, the control system could cause the speed of molten metal pump 22 to increase to pump molten metal M at a greater flow rate to raise the level in second raised chamber 18 and ultimately fill the ladle. As the level of the molten metal within the ladle increased, the control system could cause the speed of molten metal pump 22 to decrease and to pump molten metal M at a lesser flow rate, thereby ultimately decreasing the flow of molten metal into the ladle. The control system could be used to stop the operation of molten metal pump 22 or degassers 80, 81 should the amount of the molten metal within a structure, such as a ladle, reach a given value or if a problem were detected. The control system could also start pump 22 based on a given parameter.

One or more devices 58 may be used to measure one or more parameters of molten metal M, such as the depth, weight, level, and/or volume, in any structure or in multiple structures. Device 58 may be located at any position and more than one device 58 may be used. Device 58 may be a laser, float, scale to measure weight, a sound or ultrasound sensor, or a pressure sensor. Device 58 is shown as a laser to measure the level of molten metal in FIGS. 4 through 8.

The control system may provide proportional control, such that the speed of molten metal pump 22 and/or degassers 80, 81 is proportional to the amount of molten metal within a structure. The control system could be customized to provide a smooth, even flow of molten metal to one or more structures such as one or more ladles or ingot molds with minimal turbulence and little chance of overflow. The control system can also help ensure a suitable amount of gas is released in the molten metal as it flows through the raised chamber 18.

FIG. 8 shows a control panel 800 that may be used with a control system. The control panel 800 may include any desired controls and displays. For example, panel 800 includes an “auto/man” (also called an auto/manual) control 802 that can be used to choose between automatic and manual control. A “device on” button 804 allows a user to turn device 58 on and off. A “metal depth” indicator 806 allows an operator to determine the depth of the molten metal as measured by device 58. An emergency on/off button 808 allows an operator to stop metal pump 22 and/or pumps 80, 81. An RPM indicator 810 allows an operator to determine the number of revolutions per minute of a predetermined shaft of molten metal pump 22 or degassers 80, 81. An AMPS indicator 812 allows the operator to determine an electric current to the motor of molten metal pump 22 or degassers 80, 81. A start button 814 allows an operator user to start molten metal pump 22, and a stop button 816 allows a user to stop molten metal pump 22.

A speed control 820 can override the automatic control system (if being utilized) and allows an operator to increase or decrease the speed of the molten metal pump. A cooling air button 825 allows an operator to direct cooling air to the pump motor.

Having thus described different embodiments of the invention, other variations and embodiments that do not depart from the spirit thereof will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired product or result.

What is claimed is:

1. A system for releasing gas into molten metal, the system comprising:
(a) a vessel for containing molten metal, the vessel comprising a bottom interior surface;
(b) a raised chamber in fluid communication with the vessel, the raised chamber comprising:
(i) a bottom interior surface positioned at least partially above the bottom interior surface of the vessel; and
(ii) a discharge for expelling molten metal from the raised chamber; and
(c) a plurality of degassers positioned in the raised chamber, the plurality of degassers releasing gas into the molten metal in the raised chamber; and
(d) a dividing wall between each of the degassers, each dividing wall including an opening through which molten metal can pass.

2. The system of claim 1 further comprising a pump positioned in the vessel for pumping the molten metal from the vessel to the raised chamber.

3. The system of claim 2 wherein the pump positioned in the vessel is selected from the group consisting of: a circulation pump and a gas-release pump.

4. The system of claim 1 wherein the degassers are in line.

5. The system of claim 1 wherein the degassers are mounted on a top wall of the raised chamber.

6. The system of claim 5 wherein the raised chamber has side walls and the top wall of the raised chamber is removably attached to the side walls.

7. The system of claim 1 wherein the degassers are rotary degassers, each rotary degasser comprising:
(a) a shaft that extends into the raised chamber; and
(b) an impeller positioned on the shaft.

8. The system of claim 1 wherein each dividing wall extends between a front interior surface of the raised chamber to a rear interior surface of the raised chamber.

9. The system of claim 8 wherein each dividing wall extends from a top interior surface of the raised chamber and a bottom interior surface of the raised chamber.

10. The system of claim 1 further comprising a plurality of openings in each dividing wall, the one or more openings for allowing molten metal to flow through the raised chamber.

11. The system of claim 1 further comprising a dividing wall between the vessel and the raised chamber, the dividing wall comprising an overflow opening for allowing molten metal to return to the vessel from the raised chamber.

12. The system of claim 11 wherein at least a portion of the overflow opening has a height H1, wherein at least a portion of the discharge in the raised chamber has a height H2, and H2 is less than H1.

13. The system of claim 12 wherein the overflow opening comprises a lower edge having the height H1, and wherein the discharge comprises a lower edge having the height H2.

14. The system of claim 11 wherein the dividing wall includes an opening positioned beneath the height H1, the opening configured to at least partially receive a base of a pump.

15. The system of claim 14 further comprising a pump positioned in the vessel, the pump comprising a base, the base positioned in the opening in the dividing wall for pumping the molten metal from the vessel to the raised chamber.

16. The system of claim 15 wherein the pump positioned in the vessel is selected from the group consisting of: a circulation pump, and a gas-release pump.

17. The system of claim 15 further comprising a seal between the base of the pump positioned in the vessel and the opening.

18. The system of claim 15 wherein the pump positioned in the vessel is a variable speed pump.

19. The system of claim 1, wherein the bottom interior surface of the raised chamber is sloped to allow molten metal to flow back into the vessel.
